(19) United States
(12) Patent Application Publication
(10) Pub. No.: US 2026/0017117 A1
(43) Pub. Date: Jan. 15, 2026

(54) DYNAMICALLY DETERMINING NODE POOL DATA

(71) Applicant: Dell Products, L.P., Round Rock, TX (US)

(72) Inventors: Michael Marrotte, Windermere, FL (US); John P. Marchese, JR., East Hampton, CT (US)

(21) Appl. No.: 18/772,887

(22) Filed: Jul. 15, 2024

(51) Int. Cl. G06F 9/50; G06F 9/455

(52) U.S. Cl. CPC G06F 9/5077; G06F 9/45558; G06F 2009/45595

(57) ABSTRACT

Architectures and techniques are described that can dynamically determine certain optimization data with respect to node or node pool configurations. For example, a maximum pod per node (MPPN) value, a recommended instance type (RIT), and a cost per pod (CPP) value can be dynamically determined. The MPPN value can be determined to prevent pod eviction during autoscaling functions associated with a node pool. The RIT can be determined to reduce operational costs that may be higher if a different instance type is used instead.

### BACKGROUND

Containerization is a lightweight virtualization technique that provides high consistency, operating systems distribution portability, efficient resource management, and consistency across multiple environments. Thus, applications or application programming interfaces (APIs) can be containerized to provide numerous benefits to service providers and their subscribers. Due to the many benefits of containerization, many container orchestration platforms (COP) and associated products have entered the marketplace to help automate and orchestrate containerization. One such example product is Kubernetes. Kubernetes is an open-sourced software tool that can effectively manage containerized applications with reduced manual intervention.

Kubernetes, as well as other COPs, provide scheduler mechanisms that can determine where to place containers (e.g., pods) in a cluster based on system resources. COPs can also provide an autoscaler mechanism that can adjust or scale the number of nodes in a node pool and/or cluster. The number of nodes can be based on the number of pods per node and the pod resource requirements in order to meet changing resource utilization demands of associated workloads.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a schematic block diagram illustrating an example container orchestration platform (COP) with a scheduler and an autoscaler in accordance with certain embodiments of this disclosure;

FIG. 2 depicts a schematic block diagram is depicted illustrating an example device that can dynamically determine certain optimization data with respect to node or node pool configurations in accordance with certain embodiments of this disclosure;

FIG. 3A depicts a schematic block diagram illustrating various examples of system resources that can be leveraged by the node pool optimizer device in accordance with certain embodiments of this disclosure;

FIG. 3B depicts a schematic block diagram illustrating various examples of input data that can be leveraged by the node pool optimizer device in accordance with certain embodiments of this disclosure;

FIG. 4 depicts example formulae and/or equations in accordance with certain embodiments of this disclosure;

FIG. 5 depicts block diagrams illustrating data-centric views or representations of the disclosed techniques in accordance with certain embodiments of this disclosure;

FIG. 6 depicts a schematic block diagram illustrating an example device that can dynamically determine a maximum pod count with respect to different node or node pool configurations in accordance with certain embodiments of this disclosure;

FIG. 7 depicts a schematic block diagram illustrating the example device that can dynamically determine a recommended instance type for nodes of a node pool with respect to different node or node pool configurations in accordance with certain embodiments of this disclosure;

FIG. 8 illustrates an example method that can dynamically determine a maximum pod count with respect to different node or node pool configurations in accordance with certain embodiments of this disclosure;

FIG. 9 illustrates an example method that can dynamically determine a recommended instance type for nodes of a node pool with respect to different node or node pool configurations in accordance with certain embodiments of this disclosure;

FIG. 10 illustrates a block diagram of an example distributed file storage system that employs tiered cloud storage in accordance with certain embodiments of this disclosure; and

FIG. 11 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

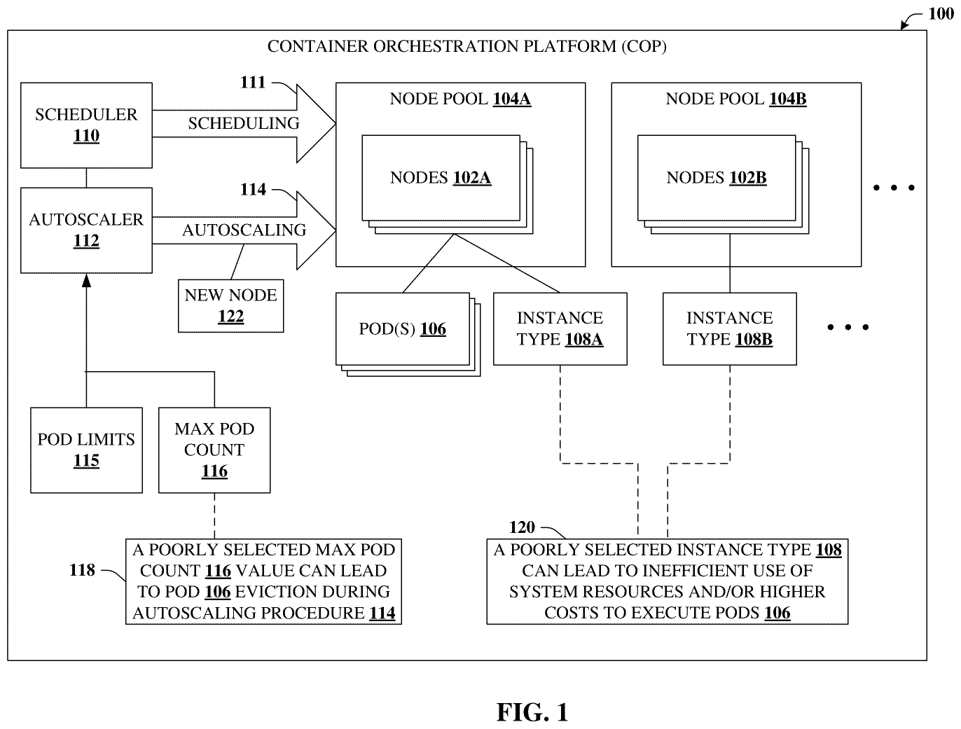

To provide additional context, consider FIG. 1. FIG. 1 shows a schematic block diagram illustrating an example container orchestration platform (COP) 100 with a scheduler 110 and an autoscaler 112 in accordance with certain embodiments of this disclosure. As a representative example used for the remainder of this document, COP 100 is presented in the context (e.g., operation and nomenclature) of a Kubernetes system, which is, today, the most widely used enterprise container orchestration platform. However, it is appreciated that the disclosed techniques can be applied to any suitable container orchestration platform, which may have different functional approaches or use different nomenclature to refer to similar functional elements. That is, the disclosed techniques can be suitably applied to any container orchestration platform or another platform that implements the functional element detailed herein as an autoscaler, a scheduler, and/or certain concepts relating to node pools.

As illustrated, COP 100 can comprise one or more nodes 102 that can be organized into various node pools 104 according to configuration (e.g., according to instance type 108, which can also be referred to as node type). For example, nodes 102A that share the same or similar instance type 108A can be assigned to node pool 102A, whereas nodes 102B having a different instance type 108B than those of nodes 102A can be assigned to node pool 104B. Thus, node pools 104 represent a logical grouping of nodes 102 within a cluster according to the individual configuration of the nodes 102 that is represented by the node type or instance type 108.

A given node 102 can be a virtual or physical machine (e.g., server) that is managed by a control plane of COP 100. Nodes 102 can be responsible for running and managing containerized applications (e.g., containers) by, for example, providing the computing resources to execute the containers. Generally, node 102 can comprise the services relied on to run and manage containerized applications (e.g., pods 106). For instance, a given node 102 can comprise one or more pods 106. Each pod 106 can represent one or more containers with shared system resources such as shared storage, networking, and specification for how to run the containers. Pods 106 can be scheduled via the control plane of COP 100 to run on a node 102 of a particular node pool 104.

In some embodiments, instance type 108 can distinguish between master nodes and worker nodes. For example, master nodes can host an application programming interface (API) server and control how, when, and where containers are run. Worker nodes can represent the compute instances where containers are run and process data.

In some embodiments, instance type 108 can refer to categories or classes of nodes 102, typically of the worker node type. For instance, platform services can provide users various options regarding compute instances (e.g., nodes 102) that are typically offered at different price levels. For example, instance type 108A can refer to varying amounts of system resources (e.g., computational resources, memory resources, . . . ) that are offered for a given node/instance type 108. In that regard, node pool 104A may comprise nodes 102A of instance type 108A that provide, e.g., four central processing unit (CPU) cores and 16 GiB of memory, whereas node pool 104B may comprise nodes 102B of instance type 108B that provides eight CPU cores and 32 GiB of memory.

As will be further explained below, typically, a user or customer is charged different rates (e.g., per hour) for using nodes 102A of instance type 108A than for nodes 102B of instance type 108B, which can complicate matters in terms of cost per resources. However, it is to be understood that there can be any suitable number of instance types 108 (e.g., small, medium, large, . . . ) and such are frequently offered to customers in terms of size (e.g., the amount of certain resources provided by an instance of a node 102 of the associated instance type 108) and price (e.g., cost per hour of use).

In that regard, it is to be appreciated that instance type 108 can be configurable and/or selectable by users or customers to execute one's own desired workloads. As indicated at reference numeral 120, a poorly selected instance type 108 can lead to inefficient use of system resources and/or higher costs associated with executing pods 106. Hence, as will be further detailed below, one advantage of the disclosed techniques can be to reduce operational costs as well as the charges to customers by determining and/or recommending an optimal or advantageous instance type 108 for a given customer's workload.

COP 100 can further comprise scheduler 110. Scheduler 110 can be indicative of a control plane process that assigns pods 106 to nodes 102. One primary responsibility of scheduler 110 can be to determine which nodes 102 are valid placements targets for each pod 106 in a scheduling queue according to available resources and certain other constraints. Scheduler 110 can then rank each valid node 102 and bind the pod 106 to a suitable node 102. In other words, scheduler 110 can be responsible for deciding which node 102 is the best fit for a given pod 106 based on various factors such as system resource availability, node affinity or anti-affinity, and so on, which is illustrated by scheduling procedure 111.

Kubernetes and other COPs often implement various types of autoscaling, illustrated here as autoscaler 112, which can perform autoscaling procedure 114. For example, horizontal autoscaling can adjust the number of replicas of an application, whereas vertical pod autoscaling can adjust the resource requests and limits of a container. Cluster autoscaling on the other hand can adjust the number of nodes in a cluster (or node pool 104), such as when pods fail to schedule or when nodes are underutilized.

For example, autoscaler 112 can automatically adjust the size (e.g., the number of nodes 102) of a cluster or node pool 104 with a goal of ensuring that all pods 106 have a place to run and that there are no unused nodes 102. In order to perform this autoscaling procedure 114, which can, for example, allocate a new node 122 to a given node pool 104, autoscaler 112 (and/or scheduler 110) can rely on certain configurable parameters such as a pod limits 115 and a max pod count 116. Pod limits 115 can be indicative of the maximum amount of a given system resource that all containers in a pod 106 can consume.

Max pod count 116 can represent the maximum number of pods 106 that can be run on a single node 102 within a given node pool 104. In the context of Kubernetes, max pod count 116 can be indicative of the max-pods-per-node parameter. This parameter is intended to be set based on available resources of a node 102, and autoscaler 112 uses the value associated with max pod count 116 to determine whether a node is eligible for scaling up (e.g., instantiating new node 122) or down (e.g., removing an unused node within node pool 104).

For example, when the max pod count 116 is reached, autoscaler 112 will typically automatically create and/or add new node 122 to the associated node pool 104. Generally, existing scheduler and autoscaling processes perform these tasks well, but in many cases, the efficiency of operation of the scheduling and autoscaling operation is limited by the quality of the input received. For instance, as indicated at reference numeral 118, if max pod count 116 is poorly selected, such can lead to pod 106 eviction during autoscaling procedure 114.

In other words, the value of max pod count 116 is a configurable parameter that can be set based on other determinations by users or system administrators. Hence, during an event in which node 102 runs out of a system resource (e.g., processing, memory, . . . ) before reaching the max pod count 116 value, autoscaler 112 will automatically create and add new node 122 to the associated node pool 104. However, if this value of max pod count 116 is poorly selected, pod 106 eviction will occur. Pod 106 eviction is an undesirable condition for deterministic workloads, as the execution of a given pod 106 will be terminated and subsequently rescheduled once new node 122 is available.

As introduced previously, certain existing scheduler and autoscaler processes function well at their respectively jobs, yet certain issues still exist. For example, existing systems that optimize node pools 104 where pod 106 and node 102 resources are known in advance largely focus on precise resource allocation in order to maximize efficiency and prevent pod evictions. Existing issues can relate to notable shortcomings with respect to resource optimization, cost-effective scaling, and dynamic adaptation.

Resource optimization typically seeks to maximize pod density per node in order to fully utilize available resources without causing over-commitment that can lead to pod evictions. Cost-effective scaling relates to selecting the optimal node type based on pod resource requirements in order to balance cost with performance efficiently. Dynamic adaptation relates to implementing an autoscaler mechanism that can be based strictly on pod counts, which can operate to ensure that pod eviction does not occur and to proactively adjust node allocations and prevent overloading situations.

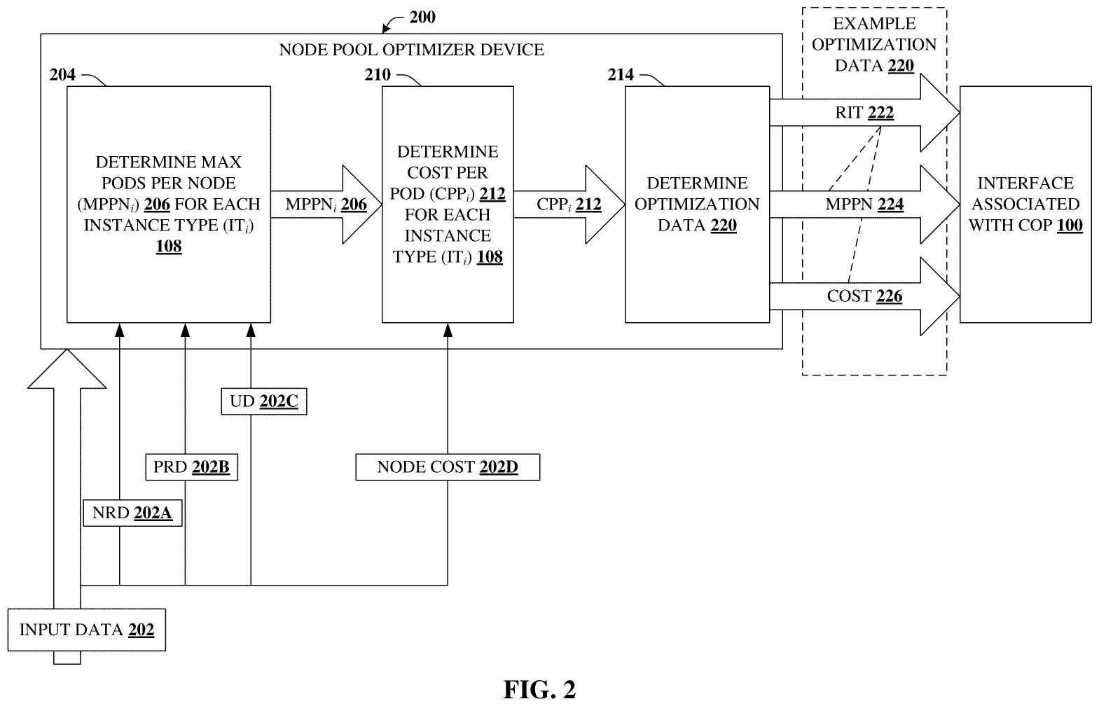

To these and other related ends, the disclosed subject matter introduces a node pool optimizer device that can improve or optimize node pools 104 based on pod 106 resource requirements, node 102 types, and node operational costs. The disclosed subject matter can leverage various techniques that implement certain formulaic aspects for determining the most cost-effective node 102 type (e.g., instance type 108) given the associated pod 106 requirements, which can operate to mitigate or avoid the issues indicated at reference numeral 120 or other related issues. The disclosed techniques can further determine an optimal or sufficient value for max pod count 116, which can mitigate or avoid the issued indicated at reference numeral 118 or other related issues, and specifically in a manner that prevents pod eviction events in connection with autoscaling procedure 114. Such can allow scheduler 110 and autoscaler 112 mechanisms to operate more efficiently and can significantly improve the ecosystem for COP 100. The proposed node pool optimizer device is further detailed in connection with FIG. 2 and other FIGS. herein.

### Example Systems

With reference now to FIG. 2, a schematic block diagram is depicted illustrating an example device 200 that can dynamically determine certain optimization data 220 with respect to node or node pool configurations in accordance with certain embodiments of this disclosure. It is to be appreciated that node pool optimizer device 200 can operate in stages such that certain output at a previous stage can be used as an input to a subsequent stage. It is to be further appreciated that node pool optimizer device 200 can operate in an iterative fashion such that determinations at a given stage can be specific to an instance type 108; so that the same or similar determination can be iterated with respect to other instance types 108.

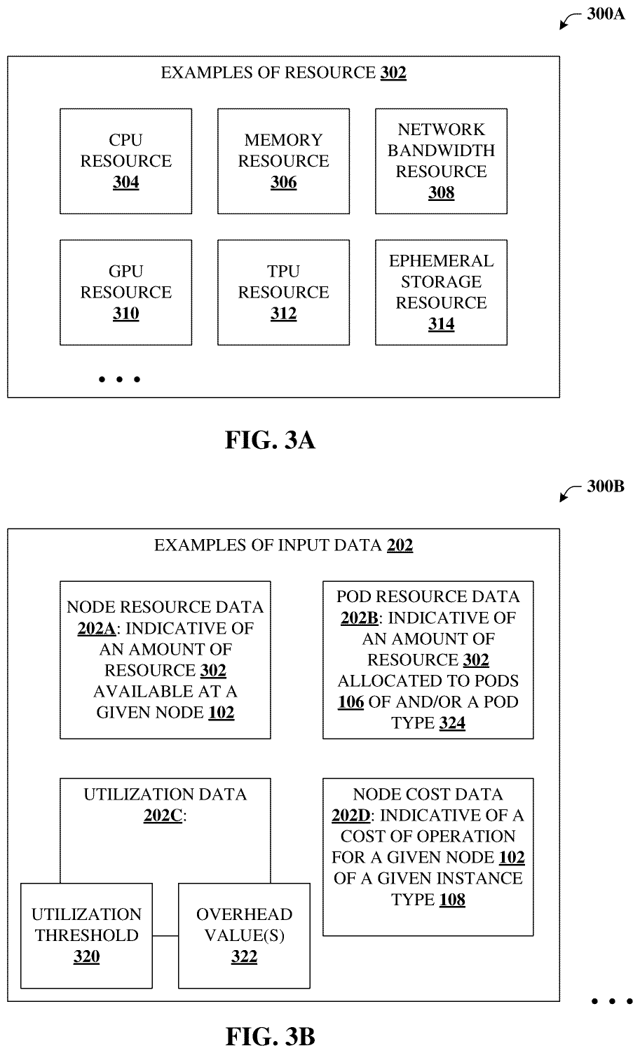

Initially, node pool optimizer device 200 can receive input data 202, which can be specific to various system resources provided, allocated, and/or required by nodes 102 and associated pods 106. Additional detail relating to system resources (e.g., resources 302) can be found with reference diagram 300A of FIG. 3A and additional detail relating to input data 202 can be found in connection with diagram 300B of FIG. 3B.

At reference numeral 204, node pool optimizer device 200 (e.g., as part of a first stage) can determine a value indicative of a maximum pods per node (MPPN) 206. MPPN 206 can represent a value for max pod count 116 that can ensure that pod eviction does not occur during autoscaling procedure 114. MPPN 206 can be a function of a particular instance type 108. Thus, at reference numeral 204, node pool optimizer device 200 can iteratively determine a given MPPNᵢ 206 for each potential instance type (ITᵢ) 108.

In order to determine MPPNᵢ 206, node pool optimizer device 200 can rely on specific portions of input data 202 such as node resource data 202A, pod resource data 202B and utilization. As illustrated in connection with FIG. 3B, node resource data 202A can be indicative of an amount of resource 302 that is provided by a given node 102 and/or available for consumption by pods 106 of that node 102. Resource 302 can be any suitable resource. While a central processing unit (CPU) resource and a memory resource are common and innately supported by many COPS 100, the resource 302 definitions can be extended to include other types of resources.

As illustrated by FIG. 3A, resource 302 can be a CPU resource 304 (e.g., CPU cores), a memory resource 306 (e.g., GiB of memory), a network bandwidth resource 308 (e.g., bandwidth, throughput, . . . ) a graphics processing unit (GPU) resource 310 (e.g., GPU cores, compute unified device architecture (CUDA) cores, . . . ), a tensor processing unit (TPU) resource 312, an ephemeral storage resource 314, and so on.

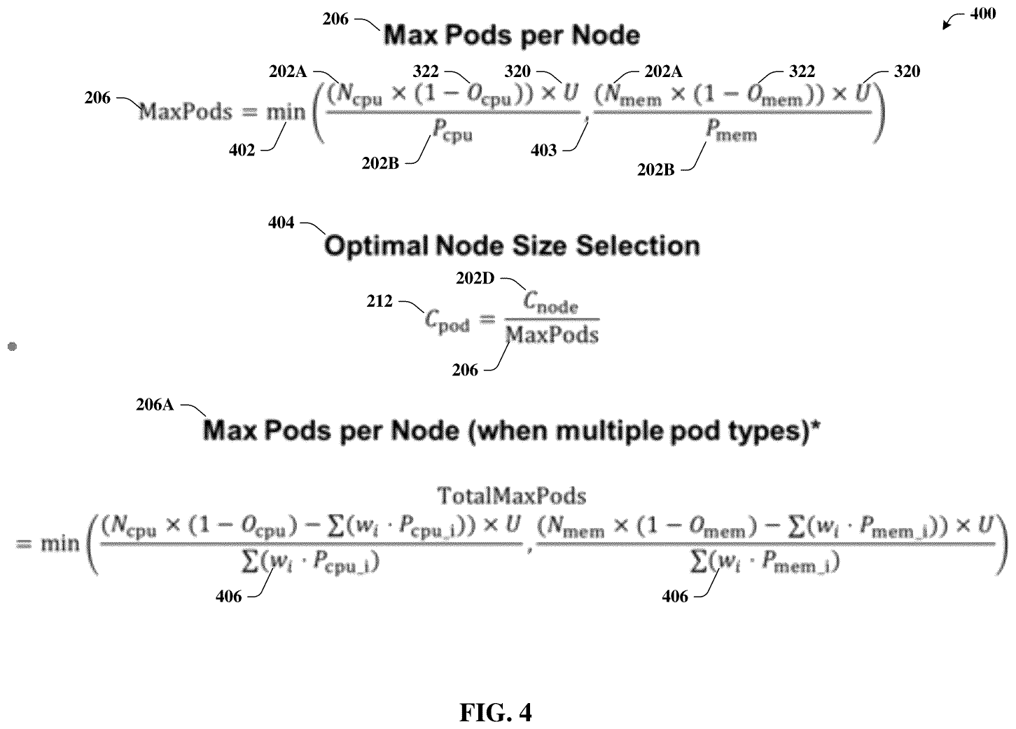

As illustrated by FIG. 3B, pod resource data 202B can be indicative of an amount of a given resource 302. As will be further detailed in connection with FIG. 4, pod resource data 202B can further comprise information relating to pod type 324.

Utilization data 202C can relate to a utilization threshold 320, an overhead threshold or value 322, or other suitable values. Utilization threshold 320 can be indicative of a target amount or fraction of node resources (e.g., 95%) that is considered optimal or normal. Utilizations that go above utilization threshold 320 can increase the risks of faults and/or hinder operational efficiency, either of which can have cascading effects. Thus, typically, going above a particular utilization threshold 320 for a particular resource is generally not desired. It is to be appreciated that each type of resource 302 can have a different utilization threshold. For example, CPU resource 304 may have a utilization threshold of 98%, whereas memory resource 306 may have a utilization threshold of 95%.

Overhead values 322 can relate to an amount or percentage of a given resource 302 that is reserved for overhead on a particular node. Thus, overhead values 322 can be different for each different type of resource 302 and can also be different for each different instance type 108 of node 102.

As a representative example of leveraging certain input data 202 (e.g., node resource data 202A, pod resource data 202B, and utilization data 202C) in order to determine MPPNᵢ 206. FIG. 4 can now be referenced along with FIG. 2.

FIG. 4 depicts example formulae and/or equations 400 in accordance with certain embodiments of this disclosure. It is to be understood that equations 400 are intended to be examples and other techniques for making the same or similar determinations can be performed in the context of this disclosure.

The first equation relates to determining max pods per node (e.g., MPPNᵢ 206) in connection with a single pod type 324, that is, when a given node 102 executes only one type of pod. As illustrated by associated reference numerals, the MaxPods parameter can be indicative of MPPNᵢ 206. N_{cpu} and Nₘₑₘ can be examples of node resource data 202A, and more specifically examples of a total amount of CPU resource 304 and a total amount of a memory resource 306, respectively, provided by a given node 102. Likewise, P_{cpu} and Pₘₑₘ can be examples of pod resource data 202B, and more specifically examples of the amount of CPU resource 304 and a total amount of a memory resource 306, respectively, allocated to a given pod 106. O_{cpu} and Oₘₑₘ can be examples of overhead values 322 (e.g., one for each different type of resource 302). U can be indicative of utilization threshold 320, which in this case is the same for both CPU resource 304 and memory resource, although it is appreciated that such could be different for CPU resource 304 and memory resource 306, as detailed above.

Holistically, it can be observed that determination of MPPNᵢ 206 (e.g., the maximum pods per node for a given instance type 108) relies on a min function 402, that is selecting the minimum derived value from among all the different factors, each of which is separated by a comma 403. Thus, multiple different factors (each separated by comma 403) can be derived, one for each type of resource 302, and the minimum can be selected to ensure that pod eviction does not occur during an autoscaling procedure 114 or another procedure. In this example, there are only two factors, one for CPU resource 304 and one for memory resource 306, but it is appreciated that other factors can exist that can be associated with other types of resource 302.

Reference numeral 206A illustrates an alternative technique for calculating MPPNᵢ 206, specifically in the case where a node 102 runs more than one type of pod 106. As with node instances that can have different types (e.g., instance type 108), pods 106 can have varying specifications as well. In that case, the form of the first equation using min function 402 can be similar, with the addition of weight factors 406, labeled as wᵢ, can be used for the different pod types. Weight factors 406 can be indicative of the amount or percentage of each pod type 324 relative to the total number of pods 106 per node 102.

Thus, still referring to FIG. 2, as explained above, node pool optimizer device 200 can determine a set of MPPNᵢ 206 values, e.g., one for each instance type 108, which can be provide to a second stage of node pool optimizer device 200, indicated at reference numeral 210. In addition to MPPNᵢ 206 values, node pool optimizer device 200 can also receive node cost data 202D. As indicated at FIG. 3B, node cost data 202D can be indicative of a cost of operation for a given node 102 of a given instance type 108. For example, node cost data 202D can be in the form of a price or cost of utilizing the node per hour (or another period).

As a function of MPPNᵢ 206 and node cost data 202D, node pool optimizer device 200 can determine a cost per pod (CPPᵢ) 212 for each instance type. In other words, node pool optimizer device 200 can derive the cost per pod based on the node cost and the maximum pods per node. In FIG. 4, CPP; 212 can be represented by C_{pod}, whereas C_{node} can be indicative of the cost to operate a node (e.g., node cost data 202D). It is to be understood that a different C_{pod} value (e.g., CPPᵢ 212) can be derived for each instance type 108. Therefore, from among the set of all CPP; 212 values, the lowest CPP; 212 value can be selected, which can indicate optimal node size selection 404.

In other words, both MPPNᵢ 206 and CPP; 212 can be determined (e.g., using equations 400) for each instance type 108. Once the set MPPNᵢ 206 values are determined (e.g., at reference numeral 204), that information can be provided to execution routines of reference numeral 210, which can determine CPP; 212 for each instance type 108. From the set of CPP; 212 values, the optimal (e.g., lowest cost implementation) instance type 108 can be determined, which can then be used by execution routines of reference numeral 214 that can determine optimization data 220.

As representative example, optimization data 220 can comprise recommended instance type 222, MPPN 224, and cost 226. Recommended instance type (RIT) 222 can be indicative of the specific instance types 108 (e.g., ITᵢ) that produced the lowest cost implementation, that is, selected from among the CPPᵢ 212 values that resulted in the lowest cost implementation. MPPN 224 (e.g., max pods per node) can be the particular MPPNᵢ 206 value that is associated with RIT 222. Cost 226 can be the cost per pod in the specific case of the instance type 108 indicated by RIT 222.

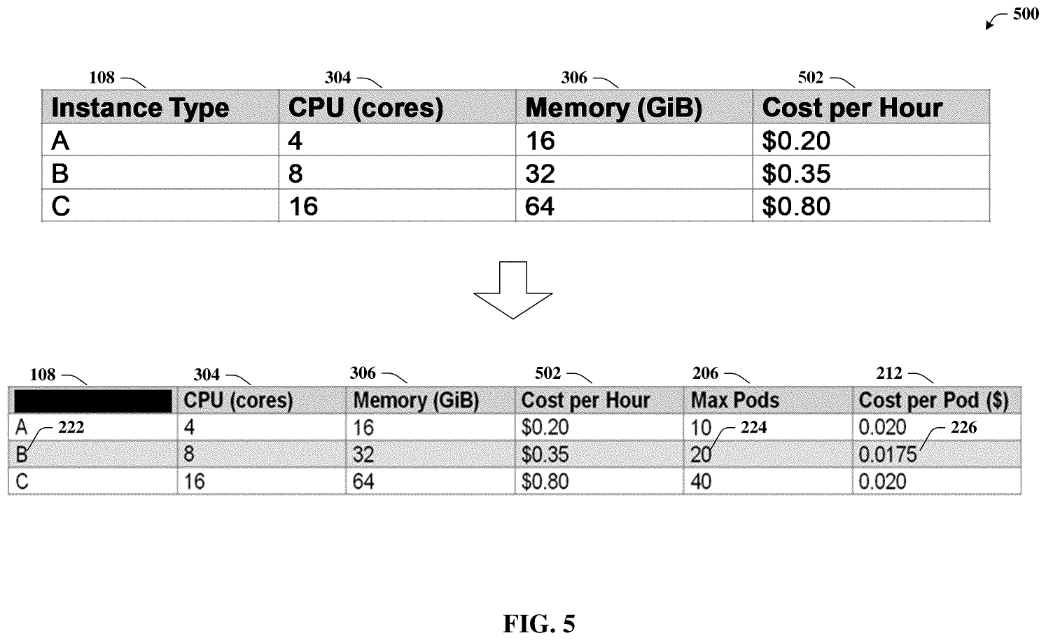

Turning now to FIG. 5, block diagrams 500 are depicted illustrating data-centric views or representations of the disclosed techniques in accordance with certain embodiments of this disclosure. By way of example, consider a COP 100 (e.g., a container-as-a-service platform) that offers customers the use of containerized workload processing at varying price points. In that regard, in this example, three different types of nodes (e.g., nodes 102) are offered. Thus, the customer can select between the various instance types 108, illustrated here as A, B, and C, each with different configuration (e.g., CPU resource 304, memory resource 306, . . . ) and different cost structure (e.g., cost per hour 502).

At first glance, an implementation in which nodes 102 have instance type A may appear to be lower, since instance type A has the lowest cost per hour. However, since nodes execute pods and each node will have a maximum pod count, it is not always apparent which instance type 108 will represent a lower cost implementation for the customer. While this simple example is illustrative of the concepts and benefits, it is understood that real world examples can be much more complex. As detailed above, node pool optimizer device 200 can determine MPPNᵢ 206, labeled here as the ‘Max Pods’ column, and CPPᵢ 212, labeled here as the ‘Cost per Pod ($)’ column.

As shown, for an implementation in which nodes 102 have instance type A in which MPPNᵢ 206 is 10 and CPP; 212 is $0.020. An implementation in which nodes 102 have an instance type C is the same price. Yet, an implementation in which nodes 102 have instance type B is cheaper than the other two with a CPPᵢ 212 of $0.0175. Thus, RIT 222 can be instance type B, MPPN 224 can be 20 and Cost 226 can be $0.0175 per pod.

It is to be appreciated that instead of considering only one dimension (e.g., node cost per hour 502) or two dimensions (e.g., node cost per hour 502 and resources 302 provided by the node) as many customers are prone to do, the disclosed techniques can pivot on many different dimensions to arrive at the optimal solution. For example, as explained herein, the disclosed techniques can implement a min-maxi-min approach to consider three different dimensions. The disclosed subject matter can determine a min function with respect to the count of pods per node based on resource 302 ratio. Further, the disclosed subject matter can determine a max function with respect to the minimum node to pod resource ratio. Further, the disclosed subject matter can determine a min function with respect to pod cost indicative of the minimum node to pod resource ratio.

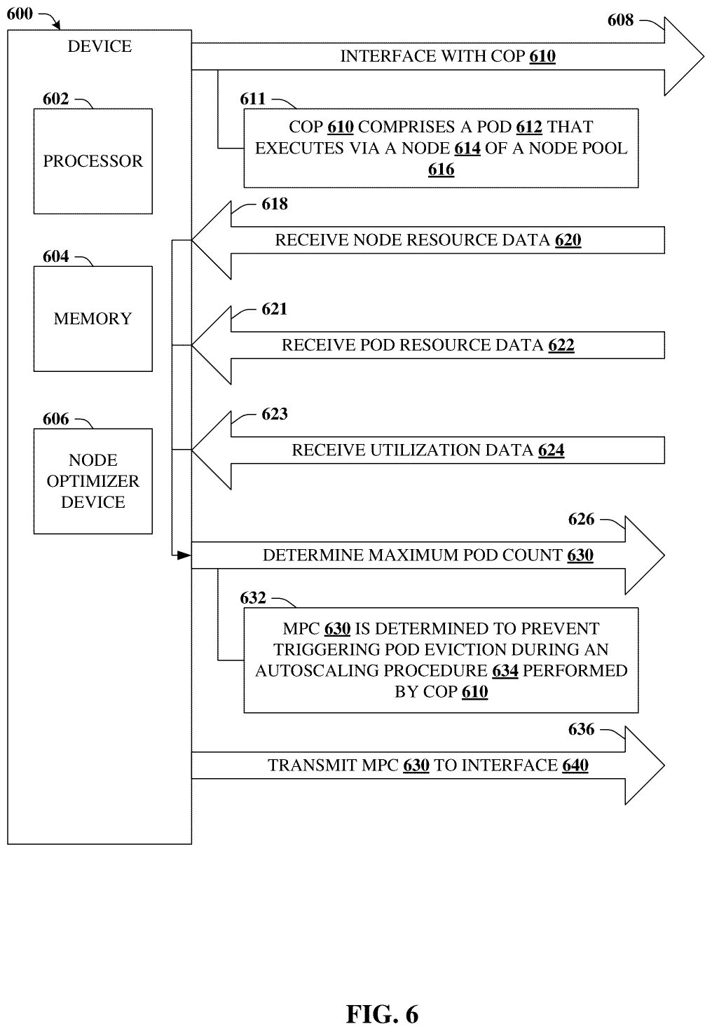

With reference now to FIG. 6, a schematic block diagram illustrating an example device 600 that can dynamically determine a maximum pod count with respect to different node or node pool configurations in accordance with certain embodiments of this disclosure. In that regard, device 600 can, in some embodiments, can be integrated into an orchestration platform such as COP 100 of FIG. 1. In some embodiments, device 600 can be communicatively coupled to the orchestration platform (e.g., executed locally). In some embodiments, device 600 can be executed in a cloud platform. Device 600 can comprise node optimizer device 606 that can include all or a portion of node pool optimizer device 200 detailed in connection with FIGS. 2-5.

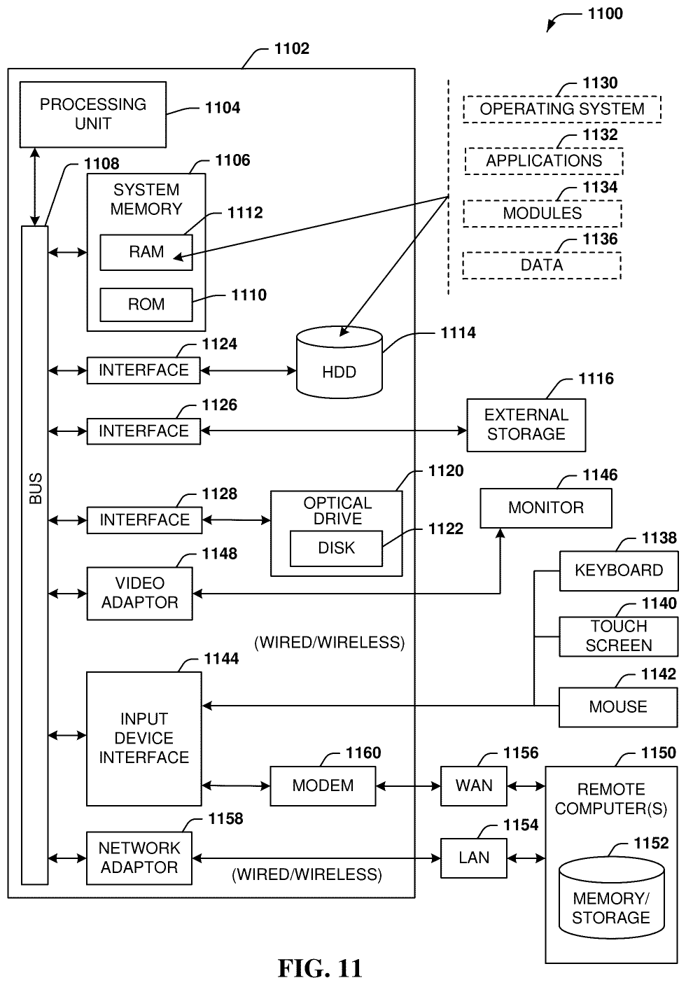

Device 600 can comprise at least one processor 602 that, potentially along with node optimizer device 606, can be specifically configured to perform functions associated with determining certain optimization data 220 with respect to node or node pool configurations. Device 600 can also comprise at least one memory 604 that stores executable instructions that, when executed by the at least one processor 602, can facilitate performance of operations. Processor(s) 602 can be a hardware processor having structural elements known to exist in connection with processing units or circuits, with various operations of processor 602 being represented by functional elements shown in the drawings herein that can require special-purpose instructions, for example, stored in memory 604 and/or temporal embedding device 606. Along with these special-purpose instructions, processor 602 and/or node optimizer device 606 can be a special-purpose device. Further examples of the memory 604 and processor 602 can be found with reference to FIG. 11. It is to be appreciated that device 600 or computer 1102 can represent a server device or a client device of a network or data services platform and computer 1102 can be used in connection with implementing one or more of the systems, devices, or components shown and described in connection with FIG. 6 and other figures disclosed herein.

As illustrated at reference numeral 608, device 600 can interface with a suitable or container orchestration platform (COP) 610 (e.g., COP 100). In that regard, COP 610 can comprise pod 612 (e.g., pod 106). Pod 612 can execute via node 614 (e.g., node 102) of node pool 616 (e.g., node pool 104). Pod 612 can be indicative of one or more containers that share system resources (e.g., resources 302). Node 614 can be indicative of one or more machines configured to execute pod 612. Node pool 616 can be indicative of a group of nodes 614 having a same instance type (e.g., instance type 108).

At reference numeral 618, device 600 can receive node resource data 620 (e.g., NRD 202A). Node resource data 620 can be indicative of a first amount of a respective resource 302 that is provided by node 614 and available for consumption by pod(s) 612 that execute on node 614. At reference numeral 621, device 600 can receive pod resource data 622 (e.g., PRD 202B). Pod resource data 622 can be indicative of a second amount of the respective resource 302 that is allocated per pod 612. At reference numeral 623, device 600 can receive utilization data 624 (e.g., UD 202C). Utilization data 624 can be indicative of a utilization threshold (e.g., utilization threshold 320) with regard to the respective resource 302. Utilization data 624 can further comprise an overhead value for the respective resource 302, as detailed in connection with overhead value 322 of FIG. 3B.

At reference numeral 626, device 600 can determine maximum pod count 630 (e.g., MPPNᵢ 206). Maximum pod count 630 can be indicative of a maximum number of pods 612 to be executed by node 614. Maximum pod count 630 can be determined as a function of node resource data 620, pod resource data 622, and utilization data 624, one example of which is provided in connection with equations 400 of FIG. 4. As indicated at reference numeral 632, maximum pod count 630 can be determined to prevent triggering pod eviction during an autoscaling procedure 634 performed by COP 610, which can be substantially similar to autoscaling procedure 114 of FIG. 1.

At reference numeral 636, device 600 can transmit maximum pod count 630 to an interface 640 associated with COP 610. For example, maximum pod count 630 can be transmitted (via interface 640) to a user or system administrator responsible for setting a parameter (e.g., max pod count 116) that is used by autoscaling procedure 634. In some embodiments, maximum pod count 630 can be transmitted directly to processes or APIs of COP 610 such as a scheduler or autoscaler device.

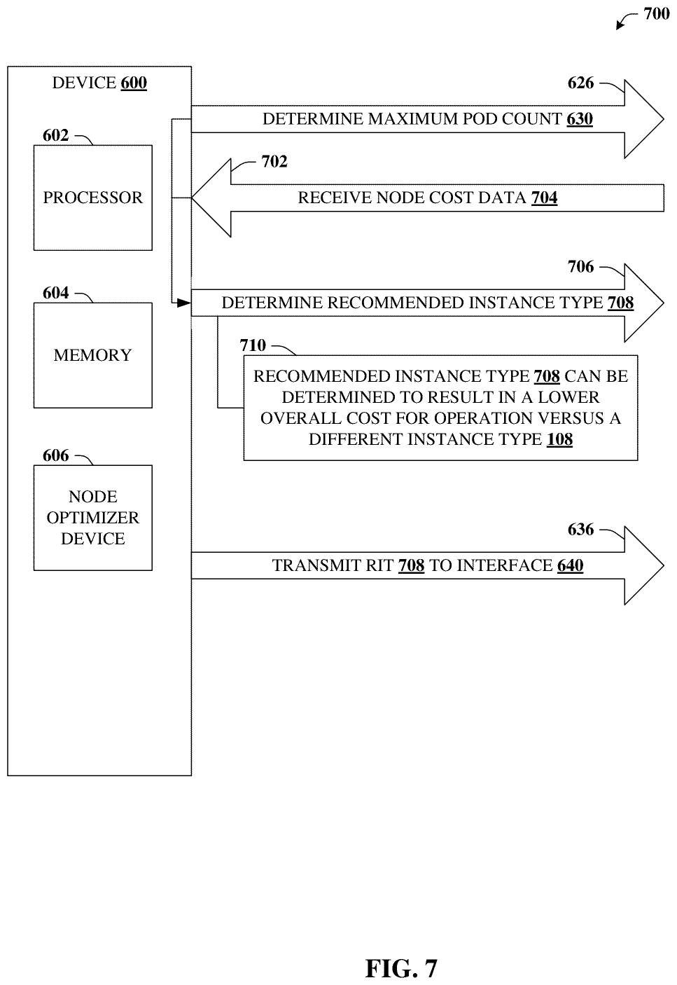

Turning now to FIG. 7, a schematic block diagram 700 illustrating the example device 600 that can dynamically determine a recommended instance type for nodes of a node pool with respect to different node or node pool configurations in accordance with certain embodiments of this disclosure. As noted with regard to FIG. 6, device 600 can determine maximum pod count 630 with respect to each available node/instance type 108.

In addition, at reference numeral 702, device 600 can receive node cost data 704 (e.g., node cost 202D). For example, node cost data 704 can be indicative of a cost or charge to the customer for utilization of the node. Typically, such is indicated in terms of currency units per hour or the like, and can vary for different node types that provide different tiers of compute power and/or resources 302.

As indicated at reference numeral 706, based on maximum pod count 630 and node cost data 704, device 600 can determine or select recommended instance type 708 (e.g., RIT 222). As illustrated at reference numeral 710, recommended instance type 708 can be determined to result in a lower overall cost for operation versus a different instance type 108. At reference numeral 636, device 600 can transmit RIT 708 to the interface 640.

### Example Methods

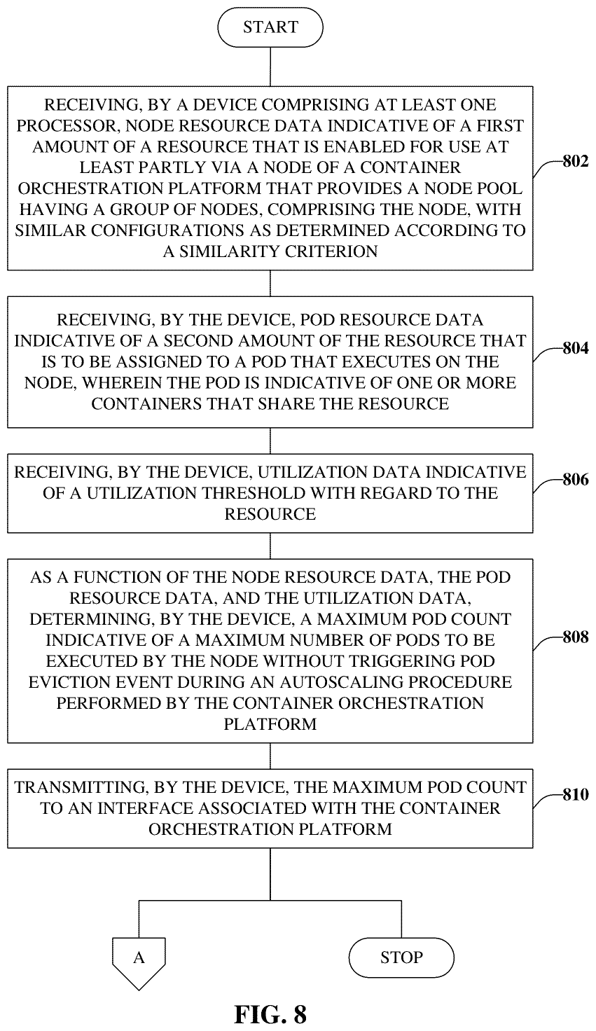

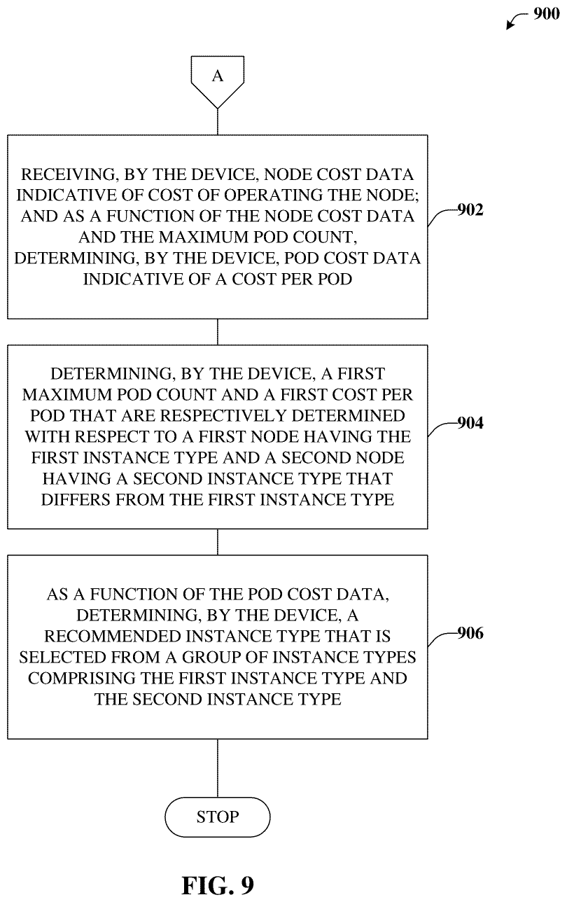

FIGS. 8 and 9 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 8, exemplary method 800 is depicted. Method 800 can dynamically determine a maximum pod count with respect to different node or node pool configurations in accordance with certain embodiments of this disclosure. While method 800 describes a complete method, in some embodiments, method 800 can include one or more elements of method 900, as illustrated by insert A.

At reference numeral 802, a device comprising at least one processor can receive node resource data. The node resource data can be indicative of a first amount of a resource that is enabled for use at least partly via a node of a container orchestration platform. The container orchestration platform can be configured to provide a node pool having a group of nodes, comprising the node, that share an instance type. In other words, nodes of a particular node pool will have similar configurations as determined according to a similarity criterion such as the instance type.

At reference numeral 804, the device can receive pod resource data. Pod resource data can be indicative of a second amount of the resource that is to be assigned to a pod that executes on the node. The pod can be indicative of one or more containers that share the resource. At reference numeral 806, the device can receive utilization data. The utilization data can be indicative of a utilization threshold with regard to the resource. The utilization data can further be indicative of overhead values for a given resource. The overhead values can indicate amounts of the resource that are reserved for operating system or other overhead allocations.

At reference numeral 808, as a function of the node resource data, the pod resource data, and the utilization data, the device can determine a maximum pod count. The maximum pod count can be indicative of a maximum number of pods to be executed by the node. The maximum pod count can be determined such that a pod eviction event does not occur during an autoscaling procedure performed by the container orchestration platform.

At reference numeral 810, the device can transmit the maximum pod count to an interface associated with the container orchestration platform. Method 800 can terminate or continue to insert A, which is further detailed in connection with FIG. 9.

Turning now to FIG. 9, exemplary method 900 is depicted. Method 900 can dynamically determine a recommended instance type for nodes of a node pool with respect to different node or node pool configurations in accordance with certain embodiments of this disclosure.

At reference numeral 902, the device introduced at reference numeral 802 comprising at least one processor can receive node cost data. The node cost data can be indicative of a cost of operating the node, for example, the cost for operating the node over a defined period of time such as per hour. As a function of the node cost data and the maximum pod count, the device can further determine pod cost data, which can be indicative of a cost per pod.

At reference numeral 904, the device can determine a first maximum pod count and a first cost per pod that are respectively determined with respect to a first node having a first instance type and a second node having a second instance type that differs from the first instance type.

At reference numeral 906, the device can, as a function of the pod cost data, determine a recommended instance type. The recommended instance type can be selected from a group of instance types comprising the first instance type and the second instance type.

### Example Operating Environments

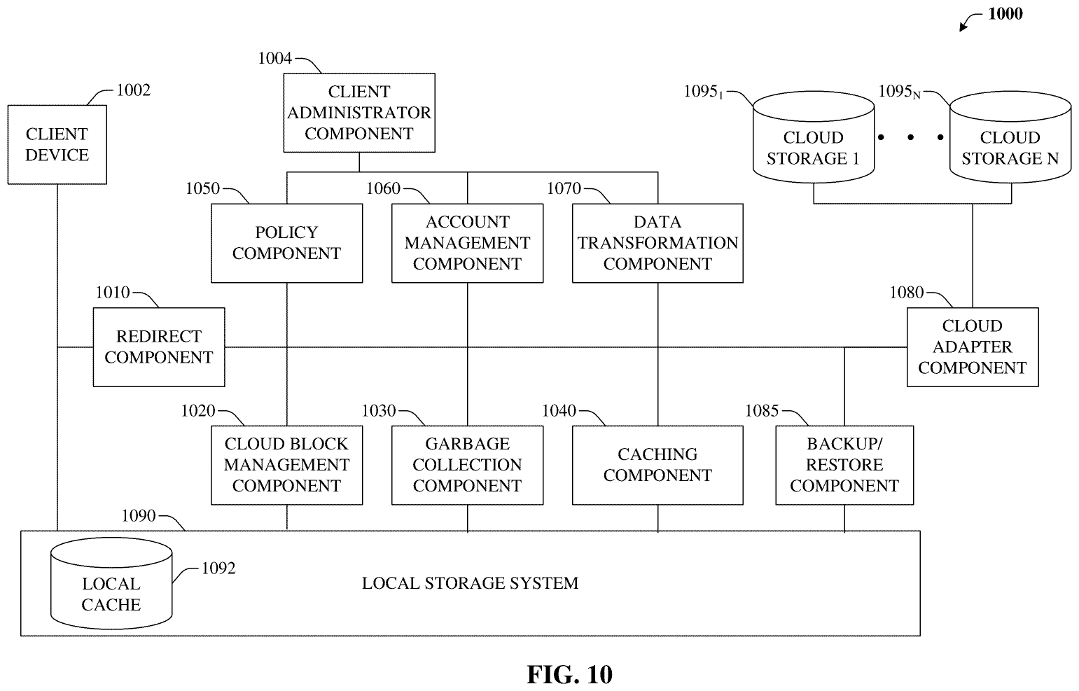

To provide further context for various aspects of the subject specification, FIGS. 10 and 11 illustrate, respectively, a block diagram of an example distributed file storage system 1000 that employs tiered cloud storage and block diagram of a computer 1102 operable to execute the disclosed storage architecture in accordance with aspects described herein.

Referring now to FIG. 10, there is illustrated an example local storage system including cloud tiering components and a cloud storage location in accordance with implementations of this disclosure. Client device 1002 can access local storage system 1090. Local storage system 1090 can be a node and cluster storage system such as an EMC Isilon Cluster that operates under OneFS operating system. Local storage system 1090 can also store the local cache 1092 for access by other components. It can be appreciated that the systems and methods described herein can run in tandem with other local storage systems as well.

As more fully described below with respect to redirect component 1010, redirect component 1010 can intercept operations directed to stub files. Cloud block management component 1020, garbage collection component 1030, and caching component 1040 may also be in communication with local storage system 1090 directly as depicted in FIG. 10 or through redirect component 1010. A client administrator component 1004 may use an interface to access the policy component 1050 and the account management component 1060 for operations as more fully described below with respect to these components. Data transformation component 1070 can operate to provide encryption and compression to files tiered to cloud storage. Cloud adapter component 1080 can be in communication with cloud storage 1 1095₁ and cloud storage N 1095_{N}, where N is a positive integer. It can be appreciated that multiple cloud storage locations can be used for storage including multiple accounts within a single cloud storage location as more fully described in implementations of this disclosure. Further, a backup/restore component 1085 can be utilized to back up the files stored within the local storage system 1090.

Cloud block management component 1020 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1020 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1060 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1020 based on list of mappings it manages. For example, each stub can be associated with an account, and the cloud block management component 1020 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1080 manages the sending and receiving of data to and from the cloud service providers. The cloud adapter component 1080 can utilize a set of APIs. For example, each cloud service provider may have provider specific API to interact with the provider.

A policy component 1050 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1030. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1030 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1040 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1020, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1040 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1040 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1070 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 1085 can transfer a copy of the files within the local storage system 1090 to another cluster (e.g., target cluster). Further, the backup/restore component 1085 can manage synchronization between the local storage system 1090 and the other cluster, such that, the other cluster is timely updated with new and/or modified content within the local storage system 1090.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1102.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
interfacing with a container orchestration platform comprising a pod that executes via a node of a node pool, wherein the pod is indicative of one or more containers that share system resources, the node is indicative of one or more machines configured to execute the pod, and the node pool is indicative of a group of nodes, comprising the node, having a same instance type;
receiving node resource data indicative of a first amount of a resource, of the system resources, that is provided by the node and available for consumption by the pod;
receiving pod resource data indicative of a second amount of the resource that is allocated per pod;
receiving utilization data indicative of a utilization threshold with regard to the resource;
as a function of the node resource data, the pod resource data, and the utilization data, determining a maximum pod count indicative of a maximum number of pods to be executed by the node, wherein the maximum pod count is determined to prevent triggering pod eviction event during an autoscaling procedure performed by the container orchestration platform; and
transmitting the maximum pod count to an interface associated with the container orchestration platform.

2. The device of claim 1, wherein the one or more machines are at least one of a physical server or a virtual server.

3. The device of claim 1, wherein the resource comprises a first resource and a second resource that differs from the first resource, wherein the maximum pod count is determined as a min function of a first maximum pod count determined with respect to the first resource and a second maximum pod count determined with respect to the second resource.

4. The device of claim 1, wherein the resource is at least one of a central processing unit (CPU) resource, a memory resource, a network bandwidth resource, a graphics processing unit resource, a tensor processing unit resource, or an ephemeral storage resource.

5. The device of claim 1, wherein the pod is a first pod having a first pod type and the node executes the first pod and a second pod having a second type that differs from the first type, wherein the maximum pod count is determined as a min function of a first maximum pod count determined with respect to the first pod having the first pod type and a second maximum pod count determined with respect to the second pod having the second pod type based on a weighting factor indicative of a relative number of pods having the first type or the second type.

6. The device of claim 1, wherein the operations further comprise:
receiving node cost data indicative of cost of operating the node; and
as a function of the node cost data and the maximum pod count, determining pod cost data indicative of a cost per pod.

7. The device of claim 6, wherein the operations further comprise transmitting the pod cost data to the interface associated with the container orchestration platform.

8. The device of claim 6, wherein the node is a first node having a first instance type indicative of amounts of the resource provided by the first node, wherein the maximum pod count comprises a first maximum pod count determined with respect to the first node having the first instance type and a second node having a second instance type that differs from the first instance type.

9. The device of claim 8, wherein the pod cost data comprises a first cost per pod with respect to the first node having the first instance type and a second cost per pod with respect to the second node having the second instance type.

10. The device of claim 8, wherein the operations further comprise, as a function of the pod cost data, determining a recommended instance type that is selected from a group of instance types comprising the first instance type and the second instance type.

11. The device of claim 10, wherein the operations further comprise transmitting the recommended instance type to the interface associated with the container orchestration platform.

12. A device, comprising:
at least one processor; and
at least one memory that stores executable instructions that, when executed by the at least one processor, facilitate performance of operations, comprising:
interfacing with a container orchestration platform comprising a pod that executes via a node of a node pool, wherein the pod is indicative of one or more containers that share system resources, the node, having an instance type from among instance types, is indicative of one or more machines configured to execute the pod, and the node pool is indicative of a group of nodes, comprising the node, having a same instance type;
receiving node resource data indicative of a first amount of a resource that is enabled at least partially by the node and available for consumption by the pod, pod resource data indicative of a second amount of the resource that is allocated per pod, utilization data indicative of a utilization threshold with regard to the resource, and node cost data indicative of cost of operating the node;
as a function of the node resource data, the pod resource data, and the utilization data, determining a pod count indicative of a maximum number of pods to be executed via the node;
as a function of the pod count and the node cost data, selecting a recommended instance type, from among the instance types, that is determined to result in a lower overall cost for operation versus a different instance type of the instance types;
transmitting the recommended instance type to an interface associated with the container orchestration platform.

13. The device of claim 12, wherein the resource comprises a first resource and a second resource that differs from the first resource, wherein the pod count is a maximum pod count, and wherein the maximum pod count is determined as a min function of a first maximum pod count determined with respect to the first resource and a second maximum pod count determined with respect to the second resource.

14. The device of claim 12, wherein the pod is a first pod having a first pod type and the node executes the first pod and a second pod having a second type that differs from the first type, wherein the pod count is a maximum pod count, and wherein the maximum pod count is determined as a min function of a first maximum pod count determined with respect to the first pod having the first pod type and a second maximum pod count determined with respect to the second pod having the second pod type based on a weighting factor indicative of a relative number of pods having the first type or the second type.

15. The device of claim 12, wherein the node is a first node having a first instance type indicative of amounts of the resource provided by the node, wherein the pod count is a maximum pod count, and wherein the maximum pod count comprises a first maximum pod count determined with respect to the first node having the first instance type and a second node having a second instance type that differs from the first instance type.

16. The device of claim 15, wherein the operations further comprise determining pod cost data indicative of a cost per pod, and wherein the pod cost data comprises a first cost per pod with respect to the first node having the first instance type and a second cost per pod with respect to the second node having the second instance type.

17. A method, comprising:
receiving, by a device comprising at least one processor, node resource data indicative of a first amount of a resource that is enabled for use at least partly via a node of a container orchestration platform that provides a node pool having a group of nodes, comprising the node, that share an instance type;
receiving, by the device, pod resource data indicative of a second amount of the resource that is to be assigned to a pod that executes on the node, wherein the pod is indicative of one or more containers that share the resource;
receiving, by the device, utilization data indicative of a utilization threshold with regard to the resource;
as a function of the node resource data, the pod resource data, and the utilization data, determining, by the device, a maximum pod count indicative of a maximum number of pods to be executed by the node without triggering pod eviction event during an autoscaling procedure performed by the container orchestration platform, and
transmitting, by the device, the maximum pod count to an interface associated with the container orchestration platform.

18. The method of claim 17, further comprising:
receiving, by the device, node cost data indicative of cost of operating the node; and
as a function of the node cost data and the maximum pod count, determining, by the device, pod cost data indicative of a cost per pod.

19. The method of claim 18, further comprising determining, by the device, a first maximum pod count and a first cost per pod that are respectively determined with respect to a first node having a first instance type and a second node having a second instance type that differs from the first instance type.

20. The method of claim 19, further comprising, as a function of the pod cost data, determining, by the device, a recommended instance type that is selected from a group of instance types comprising the first instance type and the second instance type.
